(19) United States
(12) Patent Application Publication
(10) Pub. No.: US 2014/0344481 A1
(43) Pub. Date: Nov. 20, 2014

(54) DETECTING SYSTEM FOR HARD DISK DRIVE

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventors: BO TIAN, Shenzhen (CN); KANG WU, Shenzhen (CN)

(73) Assignees: HONG FU JIN PRECISION INDUSTRY (ShenZhen) CO., LTD., Shenzhen (CN); HON HAI PRECISION INDUSTRY CO., LTD., New Taipei (TW)

(21) Appl. No.: 14/277,792

(22) Filed: May 15, 2014

(30) Foreign Application Priority Data
May 15, 2013 (CN) 2013101797967

(51) Int. Cl. G06F 3/06

(52) U.S. Cl. CPC G06F 3/0653; G06F 3/0604; G06F 3/0676; G06F 2003/0697
USPC 710/16

(57) ABSTRACT

A detecting circuit for a hard disk drive includes a controller, a first connector, a second connector connected to the first connector, a processor, a feedback circuit, and an indicator circuit. The controller outputs a control signal to the indicator circuit upon receiving feedback data from the feedback circuit, to control the indicator circuit to send out an indicator message. The processor determines whether a connection between the first and second connectors or the hard disk drive is the cause of a malfunction depending on the indicator message sent out by the indicator circuit.

### FIELD

The present disclosure relates to a detecting system for hard disk drives (HDDs).

### BACKGROUND

A number of HDDs and a backplane are adapted to serve as a redundant array of independent disks (RAID). Accordingly, the HDDs need to perform many kinds of tests.

### BRIEF DESCRIPTION OF THE DRAWINGS

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a block diagram of an embodiment of a detecting system of the present disclosure.

FIG. 2 is a circuit diagram of the detecting system of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

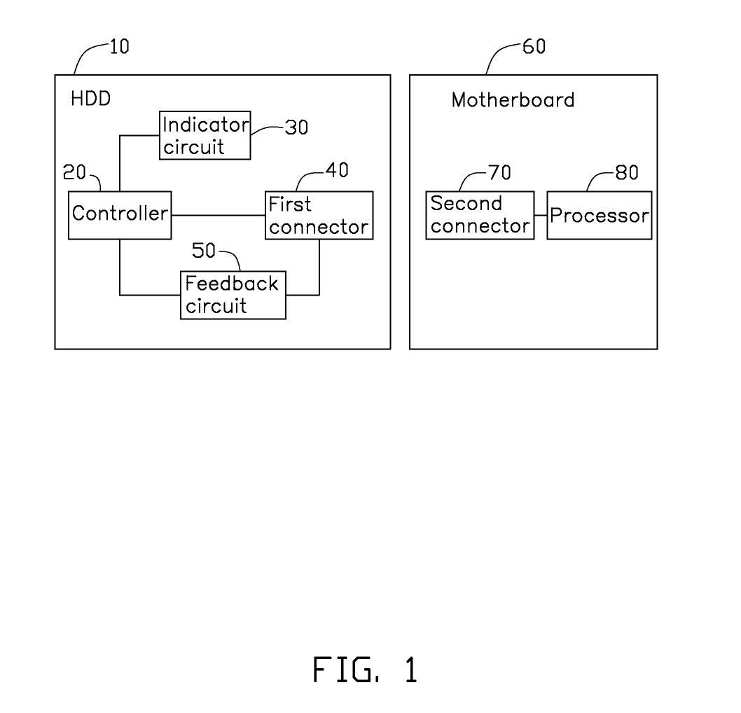

FIG. 1 illustrates an embodiment of a detecting system of the present disclosure. The detecting system can comprise a plurality of hard disk drives (HDDs, only one shown) 10, and a motherboard 60 coupled to the HDDs 10.

Each of the HDDs 10 can comprise a first connector 40, a controller 20 connected to the first connector 40, an indicator circuit 30, and a feedback circuit 50 connected between the controller 20 and the first connector 40. The motherboard 60 can comprise a plurality of second connectors 70 (only one shown) and a processor 80. In the embodiment, the first connector 40 can be coupled to the second connectors 70. Accordingly, the HDDs 10 can communicate with the motherboard 60 through the first and second connectors 40 and 70.

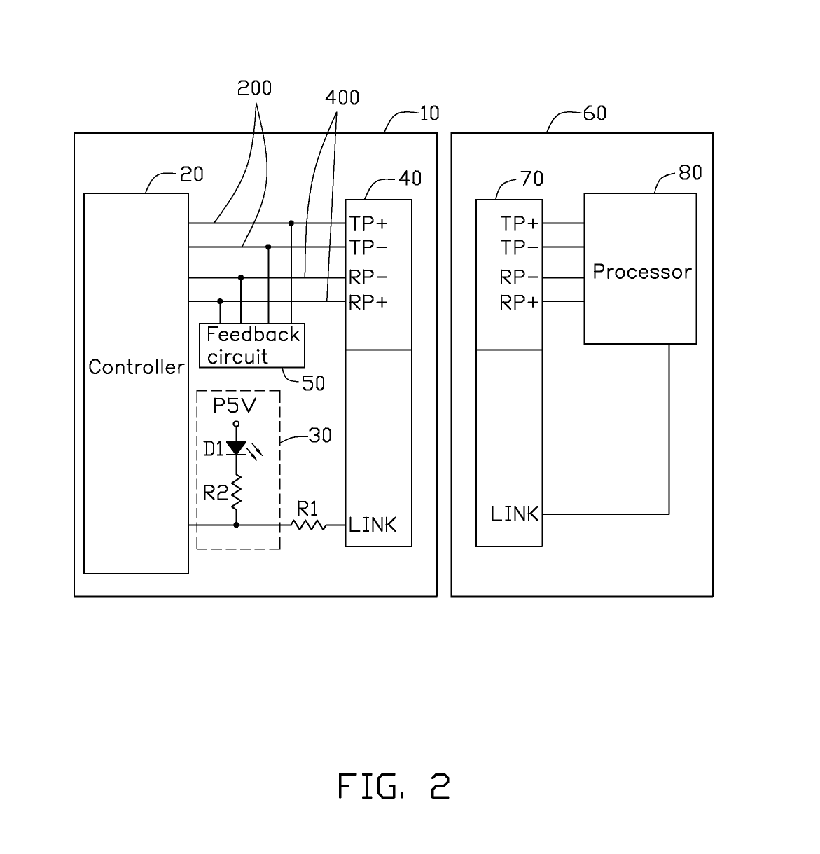

FIG. 2 illustrates a circuit diagram of the detecting system. Each first connector 40 and each second connector 70 can comprise data sending pins TP+ and TP−, data receiving pins RP+ and RP−, a connection signal generating pin LINK, and a plurality of power pins (not shown).

In the embodiment, the controller 20 and the feedback circuit 50 can be coupled to the data sending pins TP+ and TP−, and the data receiving pins RP+ and RP− of the first connector 40. The controller 20 can be further coupled to the connection signal generating pin LINK through a resistor R1. The connection signal generating pin LINK of the first connector 40 can be coupled to a cathode of a light-emitting diode (LED) D1 of the indicator circuit 30 through the resistor R1 and a resistor R2 in that order. The controller 20 can be coupled to a node of the resistors R1 and R2. An anode of the LED D1 can be coupled to a power terminal PSV. The processor 80 of the motherboard 60 can be coupled to the data sending pins TP+ and TP−, the data receiving pins RP+ and RP1, and the connection signal generating pin LINK of the second connector 70.

When the motherboard 60 is powered on, the processor 80 of the motherboard 60 can perform a test on the HDD 10. The HDD 10 can be powered on from the motherboard 60 through the power pins of the first and second connectors 40 and 70. The controller 20 can output first commands to the feedback circuit 50 through the data sending pins TP+ and TP− of the first connector 40. Upon receiving the test commands from the first connector 40, the feedback circuit 50 can output feedback data through the data receiving pins RP+ and RP−. The controller 20 can output a control signal to the indicator circuit 30 upon receiving the feedback data. For example, the controller 20 can output a low-level control signal, such as logic 0, to the cathode of the diode D1 through the resistor R2. The LED D1 then emits light, which indicates that the HDD 10 operates normally.

The processor 80 can output second commands to the controller 20 through the second and first connectors 70 and 40. The controller 20 can output a state signal to the processor 80 in response to receiving the second commands. When the processor 80 cannot receive the state signal while the LED D1 still emits light, a connection between the first and second connectors 40 and 70 is not normal. Alternatively, when the processor 80 cannot receive the state signal while the LED D1 does not emit light, the HDD 10 does not operate normally. Thus, a user can determine whether a malfunction occurs because of the HDD or because of the connection between the first and second connectors 40 and 70, according to the LED D1.

While the disclosure has been described by way of example and in terms of a preferred embodiment, it is to be understood that the disclosure is not limited thereto. On the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A detecting system, comprising:
a hard disk drive (HDD), comprising:
a first connector comprising at least one data sending pin and at least one data receiving pin;
a controller connected to the first connector;
an indicator circuit; and
a feedback circuit;
wherein when the HDD is in a normal status, the controller outputs first commands to the feedback circuit through the at least one data sending pin, the feedback circuit outputs feedback data to the controller through the at least one data receiving pin, upon receiving the first commands, the controller outputs a control signal to the indicator circuit when the controller receives the feedback data, to control the indicator circuit to send out an indicator message; and
a motherboard, comprising:
a second connector connected to the first connector, wherein the second connector comprises at least one data sending pin and at least on data receiving pin, the data receiving pin of the first connector is coupled to the data receiving pin of the second connector, the data sending pin of the first connector is coupled to the data sending pin of the second connector; and
a processor configured to perform a test on the HDD, wherein the processor outputs second commands to the controller through the second and first connectors, the controller outputs a state signal upon receiving the second commands;
wherein a connection error is indicated between the first and second connectors when the processor does not receive the state signal, and the indicator circuit sends out the indicator message; and malfunction of the HDD is indicated when the indicator circuit does not send out the indicator message.

2. The detecting system of claim 1, wherein the indicator circuit comprises a light-emitting diode (LED), a cathode of the LED is coupled to a connection signal generating pin of the first connector through a first resistor, an anode of the LED is coupled to a power terminal, and the control signal is logic-low level signal.

3. The detecting system of claim 2, wherein the controller is coupled to the connection signal generating pin through a second resistor.
